(19) United States
(12) Patent Application Publication
(10) Pub. No.: US 2012/0122521 A1
(43) Pub. Date: May 17, 2012

(54) MOBILE TERMINAL

(76) Inventors: Hayato Sato, Osaka-shi (JP); Yuki Sakai, Osaka-shi (JP); Hidekazu Morimura, Osaka-shi (JP); Satoshi Yamada, Osaka-shi (JP); Masanori Morita, Osaka-shi (JP)

(21) Appl. No.: 13/386,283

(22) PCT Filed: Jul. 15, 2010
(86) PCT No.: PCT/JP2010/061995

§ 371 Date: Jan. 20, 2012

(30) Foreign Application Priority Data
Jul. 23, 2009 (JP) 2009-172465

(51) Int. Cl. H04W 88/02

(52) U.S. Cl. 455/556.2

(57) ABSTRACT

An embodiment of a mobile terminal according to the present invention is a mobile terminal in which an upper housing is slidable relative to a lower housing. Two rotating plates are provided side by side along a lower surface of the upper housing, and rotation center points of the two rotating plates are rotatably supported by the upper housing. Two pivots are provided on the two respective rotating plates at points on circular paths having the same radius whose centers are the rotation center points of the rotating plates. The two pivots are rotatably supported by the lower housing so that the two pivots and the two rotation center points form the four corners of a parallelogram, and the two pivots are both located near a side edge of the lower housing.

### TECHNICAL FIELD

The present invention relates to mobile terminals, such as a mobile telephone, a PDA, and the like, which include an upper housing and a lower housing which are configured so that the upper housing is stacked on the lower housing and is slidable relative to the lower housing.

### BACKGROUND ART

A mobile terminal, such as a mobile telephone, a PDA, or the like, typically has two housings, i.e., an upper housing and a lower housing. The upper housing houses a display, such as an LCD or the like, and the lower housing houses a keyboard.

Such a mobile terminal typically has a flip form that the upper and lower housings fold. Recently, a sliding form that the upper housing is slid relative to the lower housing is also often employed.

In a mobile terminal having this sliding form, the upper housing is typically slid relative to the lower housing in the front-rear direction while the mobile terminal is held horizontally. Recently, a version of the sliding form has been employed in which the upper housing is slidable relative to the lower housing in the left-right direction in addition to the front-rear direction (see, for example, Patent Document 1).

In the mobile terminal of Patent Document 1 in which the upper housing is slidable relative to the lower housing in the front-rear direction and in the left-right direction, for example, when the upper housing is slid relative to the lower housing in the front-rear direction, a keyboard including a tenkey as a major component provided on a surface of the lower housing appears or is exposed, and when the upper housing is slid relative to the lower housing in the left-right direction, a full keyboard provided on the surface of the lower housing appears or is exposed. Thus, an appropriate input method can be used, depending on the situation.

Specifically, in the above mobile terminal in which the upper housing is slidable relative to the lower housing in the front-rear direction and in the left-right direction, the upper surface of the lower housing has the following three states: an upper surface covered state in which the upper surface of the lower housing is covered by the upper housing; a rear portion-of-upper surface exposed state in which the upper housing is moved forward relative to the lower housing, so that a rear portion of the upper surface of the lower housing is exposed; and a center portion-of-upper surface exposed state in which the upper housing is moved relative to the lower housing to one side in the left-right direction of the lower housing, so that a center portion and the other side in the left⁻right direction of the upper surface of the lower housing are exposed.

### PRIOR ART DOCUMENT

### Patent Documents

Patent Document 1: JP 2008-42265 A

### DISCLOSURE OF INVENTION

### Problem to be Solved by the Invention

Incidentally, in the mobile terminal of Patent Document 1, the upper housing is slid relative to the lower housing in the front-rear direction and in the left-right direction as follows. Specifically, when the upper surface of the lower housing is changed from the upper surface covered state to the rear portion-of-upper surface exposed state, the upper housing is slid forward along a straight line. When the upper surface of the lower housing is changed from the upper surface covered state to the center portion-of-upper surface exposed state, the upper housing is slid rightward along a straight line, for example.

Therefore, in the mobile terminal of Patent Document 1, the sliding direction for the transition from the upper surface covered state to the rear portion-of-upper surface exposed state intersects the sliding direction for the transition from the upper surface covered state to the center portion-of-upper surface exposed state.

In this case, the mobile terminal of Patent Document 1 requires two different sliding mechanisms having intersecting sliding directions, which need to be stacked on each other. Therefore, the thickness of the mobile terminal increases, so that the size of the housing of the mobile terminal disadvantageously increases.

Also, in the mobile terminal of Patent Document 1, when the upper surface of the lower housing is changed from the rear portion-of-upper surface exposed state to the center portion-of-upper surface exposed state, the upper surface of the lower housing needs to temporarily return from the rear portion-of-upper surface exposed state to the upper surface covered state before transitioning to the center portion-of-upper surface exposed state. This is a disadvantage to the operability of the mobile terminal.

The present invention has been made to solve the above problems. It is an object of the present invention to provide a mobile terminal including a lower housing, and an upper housing stacked on the lower housing, in which an increase in the thickness of the mobile terminal can be reduced, and in which the upper surface of the lower housing can freely transition between the three states, i.e., the upper surface covered state, the rear portion-of-upper surface exposed state, and the center portion-of-upper surface exposed state, and therefore, the mobile terminal can be operated quickly.

### Means for Solving Problem

A mobile terminal according to the present invention is one in which an upper housing provided and stacked on a lower housing is slidable relative to the lower housing. In the mobile terminal, two rotating plates are provided side by side along a lower surface of the upper housing, and rotation center points of the rotating plates are rotatably supported by the upper housing.

Two pivots are provided on the two respective rotating plates at points on circular paths having the same radius whose centers are the rotation center points of the rotating plates. The two pivots are rotatably supported by the lower housing so that the two pivots and the two rotation center points form the four corners of a parallelogram, and the two pivots are both located near a side edge of the lower housing. The mobile terminal has these features.

In the mobile terminal, the rotating plates are supported by the upper and lower housings so that the two pivots and the two rotation center points form the four corners of a parallelogram. Therefore, by changing the shape of the parallelogram whose four corners are formed by the two pivots and the two rotation center points, the upper housing is moved relative to the lower housing.

In this case, the two pivots move in the same direction. Therefore, the upper housing moves parallel to the lower housing. The translation of the upper housing relative to the lower housing allows the upper housing to slide relative to the lower housing.

In the mobile terminal, the two rotating plates rotate in synchronization with each other. With this configuration, the following operational effect can be obtained. Specifically, as described above, in the mobile terminal, the rotating plates are supported by the upper and lower housings so that the two pivots and the two rotation center points form the four corners of a parallelogram.

Therefore, the upper housing is moved relative to the lower housing by changing the shape of the parallelogram whose four corners are formed by the two pivots and the two rotation center points. In this case, the two pivots move in the same direction. Therefore, the upper housing moves parallel to the lower housing.

When the two pivots and the two rotation center points are aligned in a straight line by the movement of the upper housing, then if the two rotating plates do not rotate in synchronization with each other, the two pivots may move in different directions from that time. If the two pivots thus move in different directions, the upper housing does not move parallel to the lower housing.

However, the two rotating plates rotate in synchronization with each other. As a result, even when the two pivots and the two rotation center points are aligned in a straight line, the synchronization of the two rotating plates continues to be maintained from that time, so that the two pivots continues to move in the same direction, and therefore, the upper housing continues to move parallel to the lower housing.

The mobile terminal is, for example, configured as follows. Specifically, in the mobile terminal, the two rotating plates are arranged side by side in a front-rear direction. The two pivots are both located near a side edge in a left-right direction of the lower housing. A line joining the two rotation center points is located at substantially a middle in a left-right direction of the upper housing.

In an upper surface covered state that an upper surface of the lower housing is covered by the upper housing, the pivots are located further forward than the respective rotation center points of the rotating plates.

In the mobile terminal of the present invention thus configured, the following sliding motion is achieved.

Specifically, when the upper housing is moved along the upper surface of the lower housing so that the rotation center points perform a circular motion around the respective pivots, the pivots relatively rotate on the respective circular paths, whereby the upper housing can be moved relative to the lower housing to freely transition between three states, i.e., the upper surface covered state, a rear portion-of-upper surface exposed state, and a center portion-of-upper surface exposed state.

The upper surface covered state is a state that the upper surface of the lower housing is covered by the upper housing as described above. The rear portion-of-upper surface exposed state is a state that the upper housing is moved forward relative to the lower housing, so that a rear portion of the upper surface of the lower housing is exposed. The center portion-of-upper surface exposed state is a state that the upper housing is moved relative to the lower housing to one side in the left-right direction of the lower housing, so that a center portion and the other side in the left-right direction of the upper surface of the lower housing are exposed.

According to the mobile terminal, the aforementioned single mechanism allows the upper housing to freely transition between the three states, i.e., the upper surface covered state, the rear portion-of-upper surface exposed state, and the center portion-of-upper surface exposed state. Therefore, unlike the conventional example in which a plurality of different mechanisms are stacked on each other, the increase in the thickness of the mobile terminal can be reduced.

When the upper housing transitions from the rear portion-of-upper surface exposed state to the center portion-of-upper surface exposed state or from the center portion-of-upper surface exposed state to the rear portion-of-upper surface exposed state, the upper housing does not need to temporarily return to the upper surface covered state, i.e., can perform a direction transition between these states, whereby a quick operation is allowed in the mobile terminal.

The two pivots are both located near the side edge of the lower housing. Therefore, in the center portion-of-upper surface exposed state, the exposed portion of the upper surface of the lower housing can be enlarged.

Specifically, in the mobile terminal, when the upper housing is moved from the upper surface covered state in a clockwise (CW) direction along the upper surface of the lower housing, the upper housing transitions to the rear portion-of-upper surface exposed state, then to the center portion-of-upper surface exposed state, and then back to the upper surface covered state.

Alternatively, when the upper housing is moved from the upper surface covered state in a counterclockwise (CCW) direction along the upper surface of the lower housing, the upper housing transitions to the center portion-of-upper surface exposed state, then to the rear portion-of-upper surface exposed state, and then back to the upper surface covered state.

In the mobile terminal, the lower housing may include bearing holes in each of which a cylindrical pivot shaft is rotatably inserted, the pivot shaft having a center at a corresponding one of the pivots, and the pivot shafts may be fixed to the respective rotating plates.

In this case, when the upper housing is moved relative to the lower housing to freely transition between the three states, i.e., the upper surface covered state, the rear portion-of-upper surface exposed state, and the center portion-of-upper surface exposed state, the upper housing can be smoothly moved relative to the lower housing.

The reason why the transition motion can thus be smoothly performed is the following. Specifically, when the transition motion is performed, the rotating plates rotate around the respective pivot shafts while rotating around their own axes. The rotating shafts are cylindrical. The rotation at the pivot causes the cylindrical rotating shaft to rotate in the bearing.

Therefore, compared to the rotating shaft is a thin shaft, the cylindrical rotating shaft is a thick rotating shaft having a longer circumference, which can disperse the force applied to the rotating shaft.

In the mobile terminal, the two rotating plates preferably include gears having the same shape which rotate independently of each other, and a middle gear which engages with both of the two gears.

This configuration provides the following operational effect. Specifically, as described above, in the mobile terminal, when the two pivots and the two rotation center points are aligned in a straight line by the movement of the upper housing, then if the two rotating plates do not rotate in synchronization with each other, the two pivots may move in different directions from that time. If the two pivots thus move in different directions, the upper housing does not move parallel to the lower housing.

However, the two rotating plates include gears having the same shape which rotate independently of each other, and a middle gear which engages with both of the two gears. As a result, the two rotating plates rotate in synchronization with each other via the middle gear. Therefore, even when the two pivots and the two rotation center points are aligned in a straight line, the synchronization of the two rotating plates continues to be maintained from that time, so that the two pivots continues to move in the same direction, and therefore, the upper housing continues to move parallel to the lower housing.

In the mobile terminal in which the rotating plates include the gears, the two gears and the middle gear may be provided and recessed in the upper housing below the lower surface of the upper housing.

With this configuration, the gears and the middle gear cannot be seen from the outside, whereby the external appearance of the mobile terminal can be simplified. Also, the thickness of the mobile terminal can be reduced.

In the mobile terminal in which the rotating plates include the gears, the following configuration may be employed. Specifically, the lower housing may include bearing holes in each of which a cylindrical pivot shaft is rotatably inserted, the pivot shaft having a center at a corresponding one of the pivots, and the pivot shaft may be fixed to the rotating plate such that the pivot is located outside an outer circumference of the corresponding gear.

With this configuration, when the upper housing is in the center portion-of-upper surface exposed state, the two pivots are located outside the outer circumferences of the gears, and therefore, the exposed portion of the upper surface of the lower housing can be enlarged, compared to when the two pivots are located on the outer circumferences of the gears.

In the mobile terminal in which the rotating plates include the gears, one of the gears may have teeth formed on a portion of an entire circumference thereof. In this case, the upper housing is moved relative to the lower housing in the following manner.

Specifically, after being moved along the upper surface of the lower housing in the CW direction to transition from the upper surface covered state to the rear portion-of-upper surface exposed state and then to the center portion-of-upper surface exposed state, the upper housing is prevented from moving further in the CW direction.

In this case, in order to return it to the upper surface covered state, the upper housing is moved in the CCW direction to transition from the center portion-of-upper surface exposed state to the rear portion-of-upper surface exposed state, and then moved further in the CCW direction to transition to the upper surface covered state. Also, in this case, the upper housing is prevented from moving further in the CCW direction from the upper surface covered state.

In addition, if teeth of one of the gears are formed in a portion different from the above portion, the upper housing is moved relative to the lower housing in the following manner.

Specifically, after being moved relative to the lower housing in the CW direction to transition from the upper surface covered state to the rear portion-of-upper surface exposed state, the upper housing is prevented from moving further in the CW direction. Alternatively, after being moved relative to the lower housing in the CCW direction to transition from the upper surface covered state to the center portion-of-upper surface exposed state, the upper housing is prevented from moving further in the CCW direction.

In this case, by moving the upper housing relative to the lower housing in a direction opposite to that in which the upper housing has been originally moved, the upper housing can be returned to the upper surface covered state.

### Effects of the Invention

According to the present invention, in the mobile terminal, the rotating plates are supported by the upper and lower housings so that the two pivots and the two rotation center points form the four corners of a parallelogram. Therefore, by changing the shape of the parallelogram whose four corners are formed by the two pivots and the two rotation center points, the upper housing is moved relative to the lower housing.

In this case, the two pivots move in the same direction. Therefore, the upper housing moves parallel to the lower housing. The translation of the upper housing relative to the lower housing allows the upper housing to slide relative to the lower housing.

In the mobile terminal, the two rotating plates move in synchronization with each other. Even when the two pivots and the two rotation center points are aligned in a straight line, the synchronization of the rotation of the two rotating plates continues to be maintained from that time, so that the two pivots continues to move in the same direction, and therefore, the upper housing continues to move parallel to the lower housing.

In the mobile terminal, the single mechanism allows the upper housing to freely transition between the three states, i.e., the upper surface covered state, the rear portion-of-upper surface exposed state, and the center portion-of-upper surface exposed state. Therefore, unlike the conventional example in which a plurality of different mechanisms are stacked on each other, the increase in the thickness of the mobile terminal can be reduced.

In the mobile terminal, when the upper housing transitions from the rear portion-of-upper surface exposed state to the center portion-of-upper surface exposed state or from the center portion-of-upper surface exposed state to the rear portion-of-upper surface exposed state, the upper housing does not need to temporarily return to the upper surface covered state, i.e., can perform a direction transition between these states, whereby a quick operation is allowed in the mobile terminal.

The two pivots are both located near a side edge of the lower housing. Therefore, in the center portion-of-upper surface exposed state, the exposed portion of the upper surface of the lower housing can be enlarged.

### BRIEF DESCRIPTION OF DRAWINGS

FIG. 1 is a perspective view showing an external appearance of a mobile terminal according to an embodiment of the present invention.

FIG. 2 is a perspective view (part 1) showing a state of the mobile terminal of the embodiment of the present invention in which an upper housing has been slid relative to a lower housing.

FIG. 3 is a perspective view (part 2) showing a state of the mobile terminal of the embodiment of the present invention in which the upper housing has been slid relative to the lower housing.

FIG. 4 is a perspective view (part 3) showing a state of the mobile terminal of the embodiment of the present invention in which the upper housing has been slid relative to the lower housing.

FIG. 5 is a perspective view (part 4) showing a state of the mobile terminal of the embodiment of the present invention in which the upper housing has been slid relative to the lower housing.

FIG. 6 is a perspective view (part 5) showing a state of the mobile terminal of the embodiment of the present invention in which the upper housing has been slid relative to the lower housing.

FIG. 7 is an exploded perspective view showing a configuration of the mobile terminal of the embodiment of the present invention.

FIG. 8 is a plan view showing an internal state of the mobile terminal of the embodiment of the present invention.

FIG. 9 is a plan view (part 1) showing an internal state of the mobile terminal of the embodiment of the present invention in which the upper housing has been slid relative to the lower housing.

FIG. 10 is a plan view (part 2) showing an internal state of the mobile terminal of the embodiment of the present invention in which the upper housing has been slid relative to the lower housing.

FIG. 11 is a plan view (part 1) showing an internal state of the mobile terminal of the embodiment of the present invention in which a first rotating plate gear and a second rotating plate gear do not rotate in synchronization with each other.

FIG. 12 is a plan view (part 2) showing an internal state of the mobile terminal of the embodiment of the present invention in which the first and second rotating plate gears do not rotate in synchronization with each other.

FIG. 13 is a plan view (part 1) showing an internal state of an example of the mobile terminal of the embodiment of the present invention in which the teeth of the second rotating plate gear are formed along a portion of the entire outer circumference of the gear in an example.

FIG. 14 a plan view (part 2) showing an internal state of an example of the mobile terminal of the embodiment of the present invention in which the teeth of the second rotating plate gear are formed along a portion of the entire outer circumference of the gear in the example.

FIG. 15 a plan view (part 3) showing an internal state of an example of the mobile terminal of the embodiment of the present invention in which the teeth of the second rotating plate gear are formed along a portion of the entire outer circumference of the gear in the example.

FIG. 16 is a plan view (part 1) showing an internal state of another example of the mobile terminal of the embodiment of the present invention in which the teeth of the second rotating plate gear are formed along a portion of the entire outer circumference of the gear in another example.

FIG. 17 is a plan view (part 2) showing an internal state of another example of the mobile terminal of the embodiment of the present invention in which the teeth of the second rotating plate gear are formed along a portion of the entire outer circumference of the gear in the example.

FIG. 18 is a plan view (part 3) showing an internal state of another example of the mobile terminal of the embodiment of the present invention in which the teeth of the second rotating plate gear are formed along a portion of the entire outer circumference of the gear in the example.

FIG. 19 is a plan view (part 1) showing an internal state of the mobile terminal of the embodiment of the present invention in which a first pivot shaft and a second pivot shaft are fixed to different positions.

FIG. 20 is a plan view (part 2) showing an internal state of the mobile terminal of the embodiment of the present invention in which the first and second pivot shafts are fixed to the different positions.

FIG. 21 is a plan view (part 3) showing an internal state of the mobile terminal of the embodiment of the present invention in which the first and second pivot shafts are fixed to the different positions.

FIG. 22 is an exploded perspective view showing an internal state of a mobile terminal according to an embodiment of the present invention which employs a crank mechanism.

FIG. 23 is a plan view (part 1) showing an internal state of the mobile terminal of the embodiment of the present invention which employs the crank mechanism.

FIG. 24 is a plan view (part 2) showing an internal state of the mobile terminal of the embodiment of the present invention which employs the crank mechanism.

FIG. 25 is a plan view (part 3) showing an internal state of the mobile terminal of the embodiment of the present invention which employs the crank mechanism.

### DESCRIPTION OF EMBODIMENTS

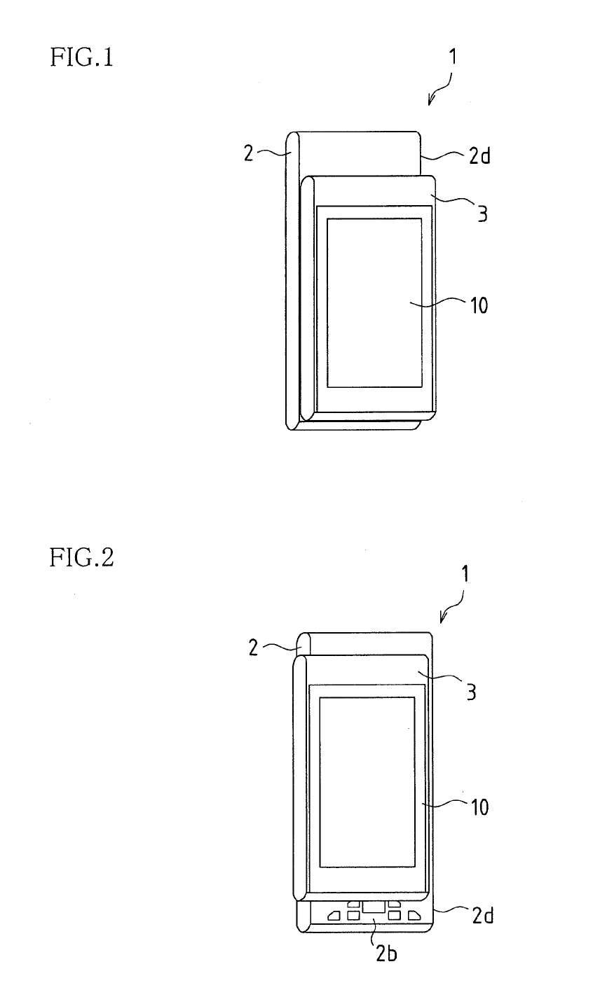

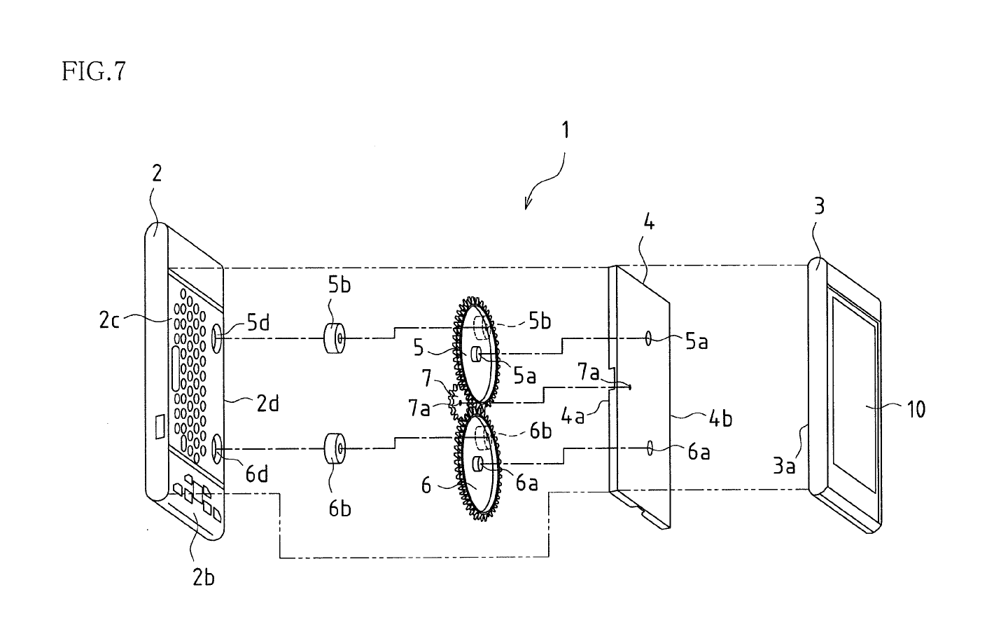

Next, a mobile terminal according to an embodiment of the present invention will be described in detail with reference to the accompanying drawings. Firstly, a configuration of the mobile terminal 1 of this embodiment will be described. FIG. 1 is a perspective view showing an external appearance of the mobile terminal 1 of this embodiment. FIG. 7 is an exploded perspective view showing the configuration of the mobile terminal 1.

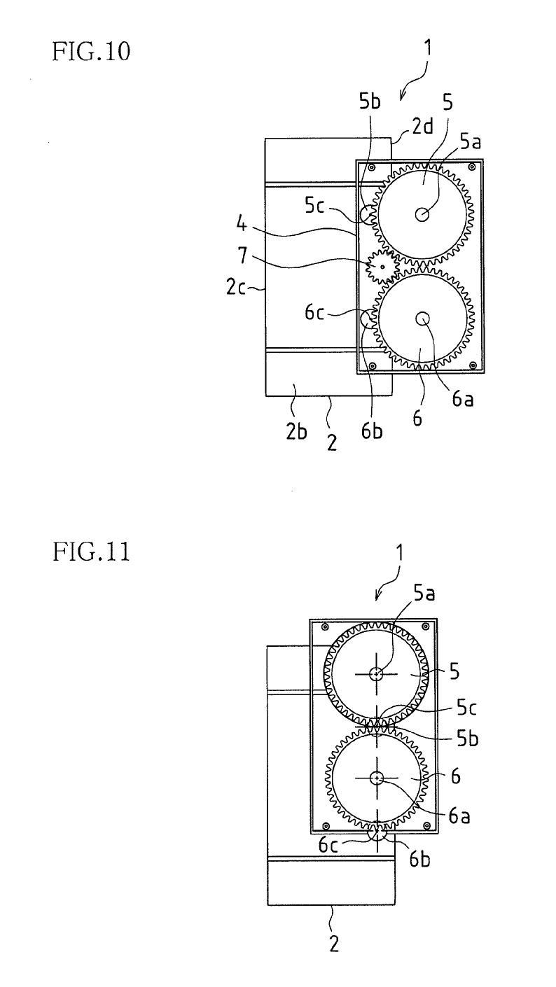

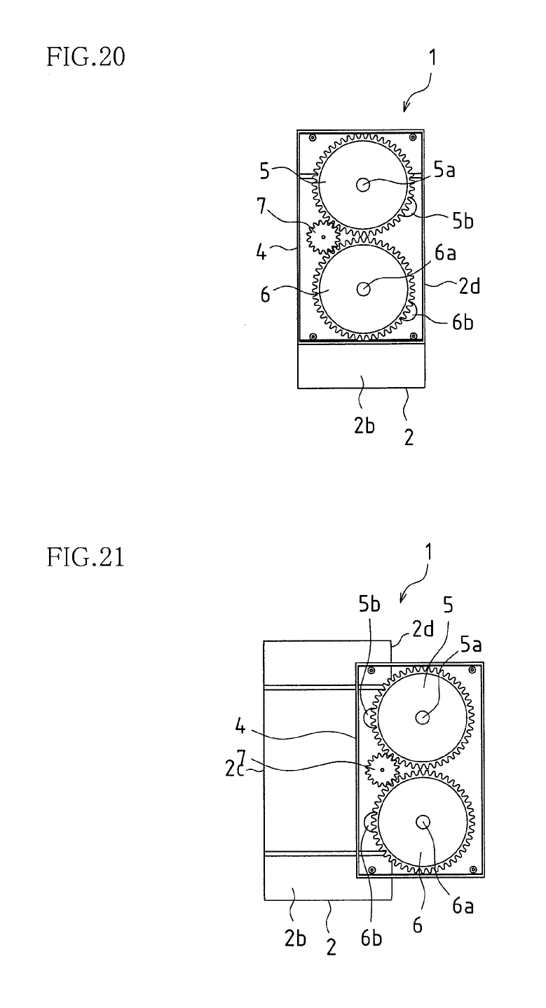

Note that, in FIG. 1, the up, down, left, right, frontward, and backward directions with respect to the drawing sheet correspond to the forward, backward, left, right, up, and down directions in the three-dimensional space, respectively. The same holds true for FIGS. 2-6, 8-21, and 23-25.

In FIGS. 1 and 7, the mobile terminal 1 of this embodiment includes, as major components, a lower housing 2, an upper housing 3, a rotating plate gear holder 4, a first rotating plate gear 5, a second rotating plate gear 6, and an middle gear 7.

The lower housing 2 houses an electronic circuit including an LSI for providing functions of the mobile terminal 1 and the like, a battery, and the like. Keyboards are provided at a rear portion 2b of an upper surface of the lower housing 2 and a center portion 2c of the upper surface of the lower housing 2. The keyboard provided at the upper surface center portion 2c is a full keyboard.

The upper housing 3 is provided and stacked on the lower housing 2. The upper housing 3 houses a display section 10 and the like.

In the mobile terminal 1 of this embodiment, the upper housing 3 is slidable relative to the lower housing 2. In order to achieve this sliding function, the mobile terminal 1 includes the rotating plate gear holder 4, the first rotating plate gear 5, the second rotating plate gear 6, and the middle gear 7.

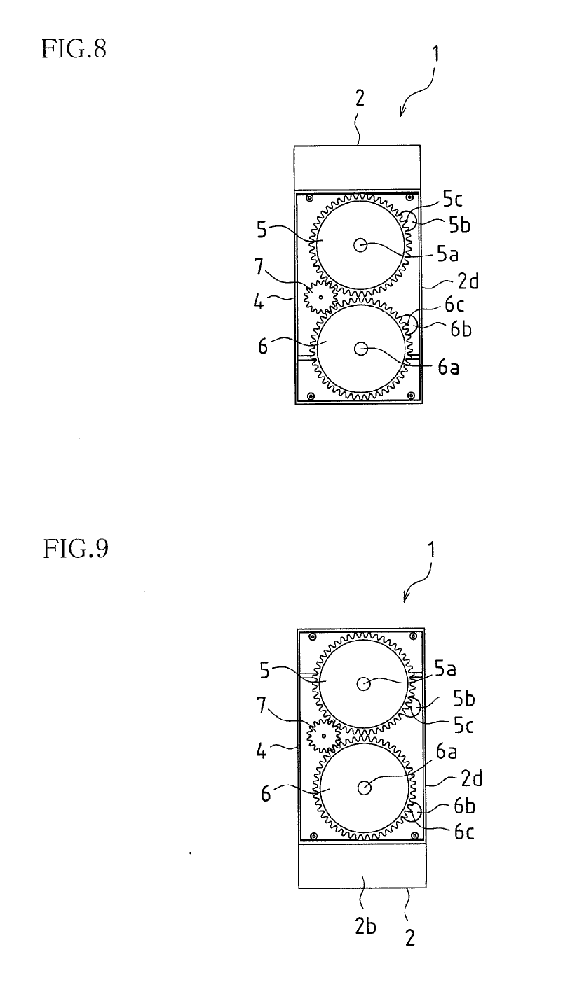

Specifically, a lower surface 3a of the upper housing 3 has an inner hollow space. The rotating plate gear holder 4 is fitted into the inner space. As shown in FIG. 8, the rotating plate gear holder 4 includes two rotating plate gears (i.e., a first rotating plate gear 5 and a second rotating plate gear 6) and the middle gear 7.

Note that FIG. 8 is a plan view of the mobile terminal 1 from which the upper housing 3 and an upper surface 4b of the rotating plate gear holder 4 are removed, as viewed from above. The same holds true for FIGS. 9-24.

In FIG. 8, the first and second rotating plate gears 5 and 6 and the middle gear 7 are arranged as follows. Specifically, the first and second rotating plate gears 5 and 6 are arranged side by side in the front-rear direction along a lower surface 4a of the rotating plate gear holder 4, i.e., the lower surface 3a of the upper housing 3.

The first and second rotating plate gears 5 and 6 do not directly engage with each other, but the middle gear 7 engages with the first and second rotating plate gears 5 and 6. Therefore, the first and second rotating plate gears 5 and 6 rotate in synchronization with each other via the middle gear.

A first rotation center shaft (center of rotation) 5a of the first rotating plate gear 5 and a second rotation center shaft (center of rotation) 6a of the second rotating plate gear 6 are rotatably supported by the rotating plate gear holder 4, i.e., the upper housing 3 so that a line joining the first rotation center shaft 5a and the second rotation center shaft 6a is located at substantially the middle in the left-right direction of the rotating plate gear holder 4, i.e., substantially the middle in the left-right direction of the upper housing 3. A center shaft 7a of the middle gear 7 is supported by the rotating plate gear holder 4, i.e., the upper housing 3.

As shown in FIG. 7, a first pivot bearing hole 5d and a second pivot bearing hole 6d which are cylindrical holes are provided near a right side edge 2d of the lower housing 2. A first pivot shaft 5b and a second pivot shaft 6b are rotatably inserted in the first and second pivot bearing holes 5d and 6d, respectively.

The cylindrical first and second pivot shafts 5b and 6b inserted in the first and second pivot bearing holes 5d and 6d are fixed to the first and second rotating plate gears 5 and 6. The first and second pivot shafts 5b and 6b are fixed to the first and second rotating plate gears 5 and 6, respectively, in the following manner.

Specifically, the first and second pivot shafts 5b and 6b are attached to the first and second rotating plate gears 5 and 6 so that a first pivot 5c and a second pivot 6c which are the center points of the first and second pivot shafts 5b and 6b are located outside circular paths having the same radius whose center points are the first and second rotation center shafts 5a and 6a which are the center points of rotation of the first and second rotating plate gears 5 and 6, respectively.

Meanwhile, the first and second pivot shafts 5b and 6b are attached to the first and second rotating plate gears 5 and 6 so that the first and second pivots 5c and 6c and the first and second rotation center shafts 5a and 6a form the four corners of a parallelogram.

As shown in FIG. 8, when the mobile terminal 1 is in an upper surface covered state that an upper surface 2a of the lower housing 2 is covered by the upper housing 3, the first and second pivots 5c and 6c are located further forward than the first and second rotation center shafts 5a and 6a of the first and second rotating plate gears 5 and 6, respectively.

As described above, in the mobile terminal 1, the upper housing 3 is slidable relative to the lower housing 2. Therefore, next, this sliding motion will be described. FIG. 1 is a perspective view showing an external appearance of the mobile terminal 1 in the upper surface covered state that the upper surface 2a of the lower housing 2 is covered by the upper housing 3. FIGS. 2-6 are perspective views showing states of the upper housing 3 which has been slid relative to the lower housing 2. FIGS. 8-10 are plan views showing internal states of the mobile terminal 1 which change as the upper housing 3 is slid relative to the lower housing 2. FIGS. 8-10 correspond to FIGS. 1, 3, and 5, respectively.

As described above, in the mobile terminal 1, the first and second rotating plate gears 5 and 6 are supported by the upper housing 3 and the lower housing 2 so that the first and second pivots 5c and 6c and the first and second rotation center shafts 5a and 6a form the four corners of a parallelogram. Therefore, by changing the shape of the parallelogram whose four corners are formed by the first and second pivots 5c and 6c and the first and second rotation center shafts 5a and 6a, the upper housing 3 is moved relative to the lower housing 2.

In this case, the first and second pivots 5c and 6c move in the same direction. Therefore, the upper housing 3 moves parallel to the lower housing 2. The translation of the upper housing 3 relative to the lower housing 2 allows the upper housing 3 to slide relative to the lower housing 2.

Specifically, when the upper housing 3 is moved along the upper surface 2a of the lower housing 2 so that the first and second rotation center shafts 5a and 6a move along respective circles whose centers are the first and second pivots 5c and 6c, the first and second pivots 5c and 6c relatively move along respective circular paths, whereby the upper housing 3 can be slid relative to the lower housing 2.

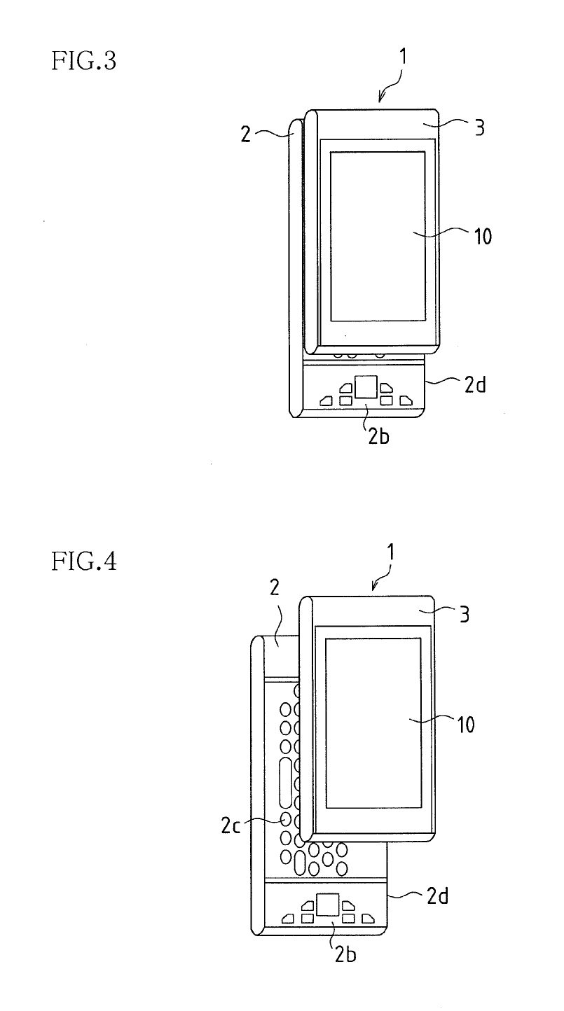

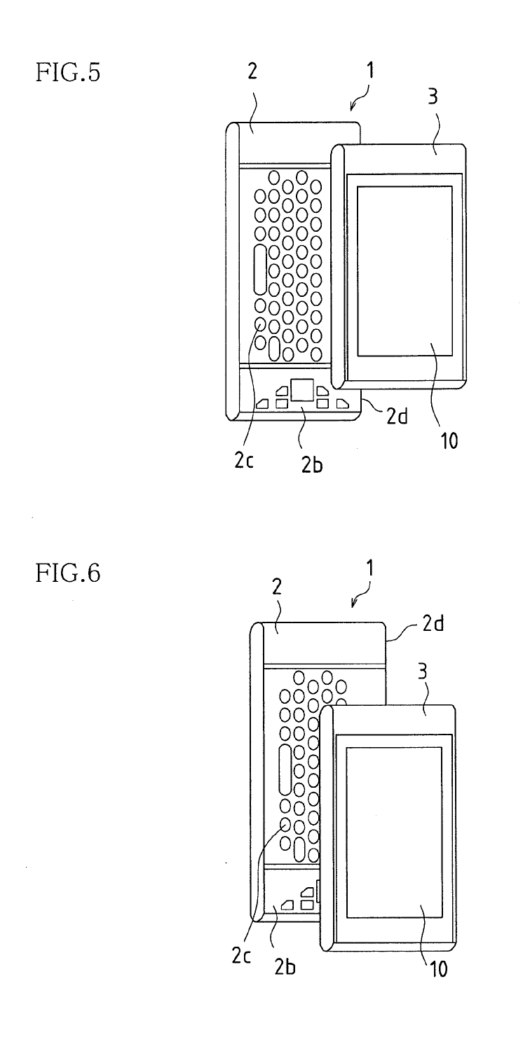

For example, this sliding motion starts from FIG. 1, transitions to FIG. 2, then to FIG. 3, then to FIG. 4, then to FIG. 5, and then to FIG. 6, and returns to FIG. 1. In this sliding motion, FIG. 1 shows the upper surface covered state that the upper surface 2a of the lower housing 2 is covered by the upper housing 3, FIG. 3 shows a rear portion-of-upper surface exposed state that the upper housing 3 is moved forward relative to the lower housing 2, so that the rear portion 2b of the upper surface 2a of the lower housing 2 is exposed, FIG. 5 shows a center portion-of-upper surface exposed state that the upper housing 3 is moved relative to the lower housing 2 to one side in the right and left directions of the lower housing 2, so that the center portion 2c and the other side in the right and left direction (the right side edge 2d) of the upper surface 2a of the lower housing 2 are exposed.

FIG. 2 shows an intermediate state between the upper surface covered state of FIG. 1 and the rear portion-of-upper surface exposed state of FIG. 3. FIG. 4 shows an intermediate state between the rear portion-of-upper surface exposed state of FIG. 3 and the center portion-of-upper surface exposed state of FIG. 5. FIG. 6 shows an intermediate state between the center portion-of-upper surface exposed state of FIG. 5 and the upper surface covered state of FIG. 1.

Specifically, in the above case, when the upper housing 3 is moved and transitioned from the upper surface covered state (FIG. 1) in the CW direction along the upper surface 2a of the lower housing 2, the upper housing 3 transitions to an intermediate state (FIG. 2), then to the rear portion-of-upper surface exposed state (FIG. 3), then to an intermediate state (FIG. 4), then to the center portion-of-upper surface exposed state (FIG. 5), then to an intermediate state (FIG. 6), then back to the upper surface covered state (FIG. 1).

Alternatively, when the upper housing 3 is moved and transitioned from the upper surface covered state (FIG. 1) in the CCW direction along the upper surface 2a of the lower housing 2, the upper housing 3 transitions to an intermediate state (FIG. 6), then to the center portion-of-upper surface exposed state (FIG. 5), then to an intermediate state (FIG. 4), then to the rear portion-of-upper surface exposed state (FIG. 3), then to an intermediate state (FIG. 2), and then back to the upper surface covered state (FIG. 1).

As described above, in the mobile terminal 1, the middle gear 7 engages with the first and second rotating plate gears 5 and 6, and therefore, the first and second rotating plate gears 5 and 6 rotate in synchronization with each other via the middle gear 7. This synchronization has the following effect.

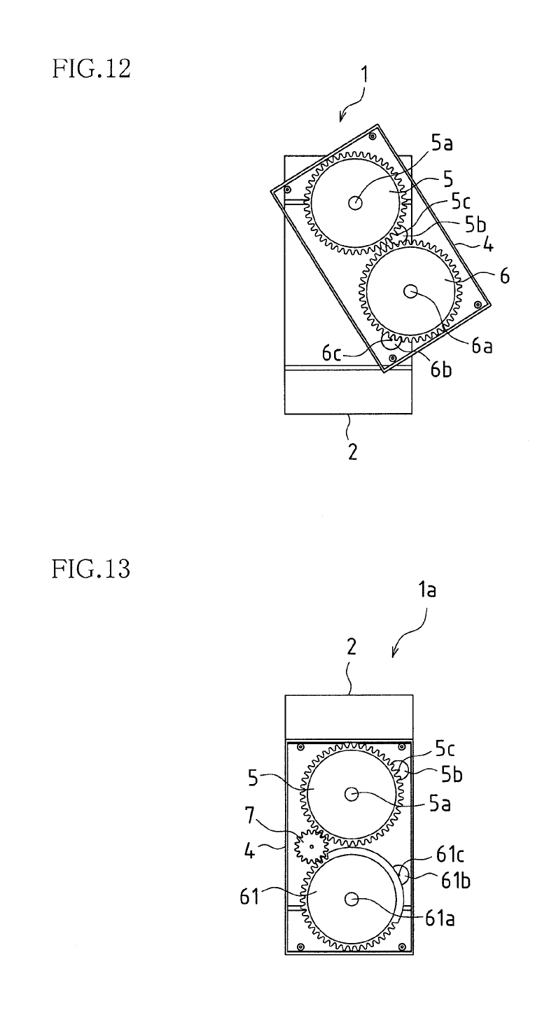

Specifically, when the first and second pivots 5c and 6c and the centers of the first and second rotation center shafts 5a and 6a are aligned in a straight line by the movement of the upper housing 3 as shown in FIG. 11, then if the middle gear 7 is absent, the first and second pivots 5c and 6c may not rotate in synchronization with the first and second rotating plate gears 5 and 6 from that time, and may move in different directions as shown in FIG. 12. If the first and second pivots 5c and 6c move in different directions in this manner, the upper housing 3 does not move parallel to the lower housing 2, as shown in FIG. 12.

As described above, however, the middle gear 7 engages with the first and second rotating plate gears 5 and 6, and therefore, the first and second rotating plate gears 5 and 6 rotate in synchronization with each other. As a result, even when the first and second pivots 5c and 6c and the centers of the first and second rotation center shafts 5a and 6a are aligned in a straight line, the synchronization of the first and second rotating plate gears 5 and 6 continues to be maintained from that time, so that the first and second pivots 5c and 6c continues to move in the same direction, and therefore, the upper housing 3 continues to move parallel to the lower housing 2.

As described above, the mobile terminal 1 includes, in the lower housing 2, the first and second pivot bearing holes 5d and 6d in which the cylindrical first and second pivot shafts 5b and 6b having the first and second pivots 5c and 6c as the centers of axes are rotatably inserted. The cylindrical first and second pivot shafts 5b and 6b are fixed to the first and second rotating plate gears 5 and 6.

Therefore, the upper housing 3 can be smoothly moved relative to the lower housing 2 when being freely transitioned between the three states, i.e., the upper surface covered state, the rear portion-of-upper surface exposed state, and the center portion-of-upper surface exposed state.

The reason why the transition motion can thus be smoothly performed is the following. Specifically, when the transition motion is performed, the first and second rotating plate gears 5 and 6 rotate around the first and second pivot shafts 5b and 6b, respectively, while rotating around their own axes. The first and second pivot shafts 5b and 6b are cylindrical.

Therefore, compared to the rotating shaft is a thin shaft, the cylindrical first and second pivot shafts 5b and 6b are each a thick rotating shaft having a longer circumference, which can disperse the force applied to the rotating shaft.

As described above, in the mobile terminal 1, the first and second pivot shafts 5b and 6b are fixed to the first and second rotating plate gears 5 and 6 so that the first and second pivots 5c and 6c which are the center points of the first and second pivot shafts 5b and 6b are located outside the outer circumferences of the first and second rotating plate gears 5 and 6, respectively.

Therefore, when the upper housing 3 is in the center portion-of-upper surface exposed state, the first and second pivots 5c and 6c are located outside the outer circumferences of the first and second rotating plate gears 5 and 6, and therefore, the exposed portion of the upper surface 2a of the lower housing 2 can be increased, compared to when the first and second pivots 5c and 6c are located on the outer circumferences of the first and second rotating plate gears 5 and 6.

In the mobile terminal 1, the first and second rotating plate gears 5 and 6 are supported by the upper housing 3 and the lower housing 2 so that the first and second pivots 5c and 6c and the first and second rotation center shafts 5a and 6a form the four corners of a parallelogram. Therefore, by changing the shape of the parallelogram whose four corners are formed by the first and second pivots 5c and 6c and the first and second rotation center shafts 5a and 6a, the upper housing 3 is moved relative to the lower housing 2.

In this case, the first and second pivots 5c and 6c move in the same direction, and therefore, the upper housing 3 moves parallel to the lower housing 2. The translation of the upper housing 3 relative to the lower housing 2 allows the upper housing 3 to slide relative to the lower housing 2.

In the mobile terminal 1, the middle gear 7 allows the first and second rotating plate gears 5 and 6 to rotate in synchronization with each other. Therefore, even when the first and second pivots 5c and 6c and the centers of the first and second rotation center shafts 5a and 6a are aligned in a straight line, the synchronization of the rotation of the first and second rotating plate gears 5 and 6 continues to be maintained from that time, and therefore, the first and second pivots 5c and 6c continue to move in the same direction, so that the upper housing 3 continues to move parallel to the lower housing 2.

In the mobile terminal 1, the aforementioned single mechanism allows the upper housing 3 to freely transition between the three states, i.e., the upper surface covered state, the rear portion-of-upper surface exposed state, and the center portion-of-upper surface exposed state. Therefore, unlike the conventional example in which a plurality of different mechanisms are stacked on each other, the increase in the thickness of the mobile terminal 1 can be reduced.

In the mobile terminal 1, when the upper housing 3 transitions from the rear portion-of-upper surface exposed state to the center portion-of-upper surface exposed state or from the center portion-of-upper surface exposed state to the rear portion-of-upper surface exposed state, the upper housing 3 does not need to temporarily return to the upper surface covered state, i.e., can perform a direction transition between these states, whereby a quick operation is allowed in the mobile terminal 1.

The first and second pivots 5c and 6c are both located near the right side edge 2d of the lower housing 2. Therefore, in the center portion-of-upper surface exposed state, the exposed portion of the upper surface 2a of the lower housing 2 can be enlarged.

In the mobile terminal 1, the first and second pivot bearing holes 5d and 6d which are cylindrical holes are provided. The cylindrical first and second pivot shafts 5b and 6b are rotatably fitted in the first and second pivot bearing holes 5d and 6d, respectively.

Therefore, compared to when the first and second pivot shafts 5b and 6b are thin shafts, the upper housing 3 can be smoothly moved relative to the lower housing 2 when the upper housing 3 is freely transitioned between the three states, i.e., the upper surface covered state, the rear portion-of-upper surface exposed state, and the center portion-of-upper surface exposed state.

In the mobile terminal 1, when the upper housing 3 is in the center portion-of-upper surface exposed state, the first and second pivots 5c and 6c are located outside the outer circumferences of the first and second rotating plate gears 5 and 6, and therefore, the exposed portion of the upper surface 2a of the lower housing 2 can be enlarged, compared to when the first and second pivots 5c and 6c are located on the outer circumferences of the first and second rotating plate gears 5 and 6.

In the mobile terminal 1, the first and second rotating plate gears 5 and 6 and the middle gear 7 are provided and recessed in the upper housing 3 below the lower surface 3a of the upper housing 3. Therefore, the first and second rotating plate gears 5 and 6 and the middle gear 7 cannot be seen from the outside, whereby the external appearance of the mobile terminal 1 can be simplified. Also, the thickness of the mobile terminal 1 can be reduced.

Incidentally, in the mobile terminal 1, the first and second rotating plate gears 5 and 6 have teeth along the entire outer circumstance thereof. Alternatively, teeth may be formed along a portion of the entire outer circumference. FIGS. 13-15 are plan views showing internal states of a mobile terminal 1a in which a second rotating plate gear 61 has teeth along a portion of the entire circumference thereof.

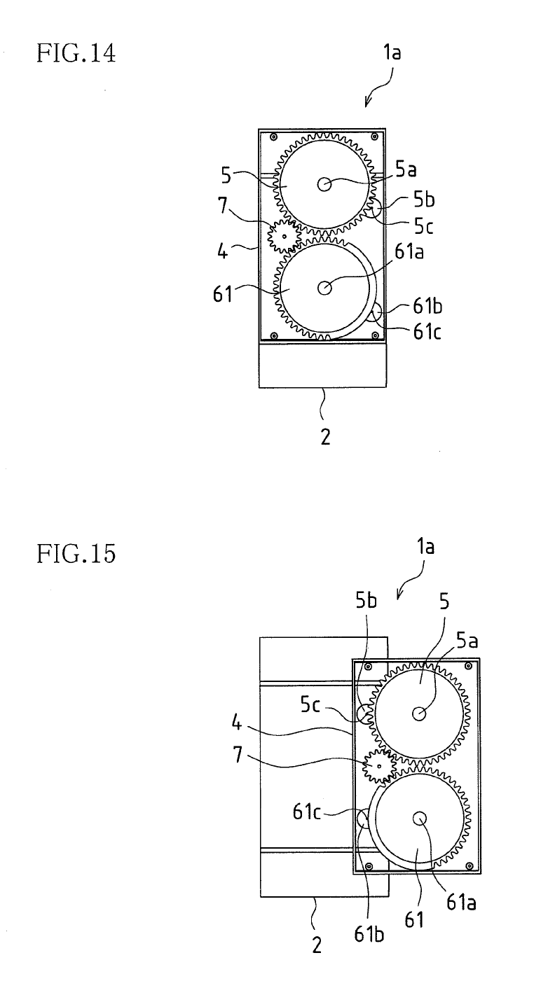

In FIGS. 13-15, after being moved along the upper surface 2a of the lower housing 2 in the CW direction to transition from the upper surface covered state (FIG. 13) to the rear portion-of-upper surface exposed state (FIG. 14) and then to the center portion-of-upper surface exposed state (FIG. 15), the upper housing 3 is prevented from moving further in the CW direction because the second rotating plate gear 61 has no teeth for allowing the upper housing 3 to move further in the CW direction.

In this case, in order to return to the upper surface covered state (FIG. 13), the upper housing 3 is moved in the CCW direction to transition from the center portion-of-upper surface exposed state (FIG. 15) to the rear portion-of-upper surface exposed state (FIG. 14), and then moved further in the CCW direction to transition to the upper surface covered state (FIG. 13). Also, in this case, the upper housing 3 is prevented from moving further in the CCW direction from the upper surface covered state because the second rotating plate gear 61 has no teeth for allowing the upper housing 3 to move further in the CCW direction.

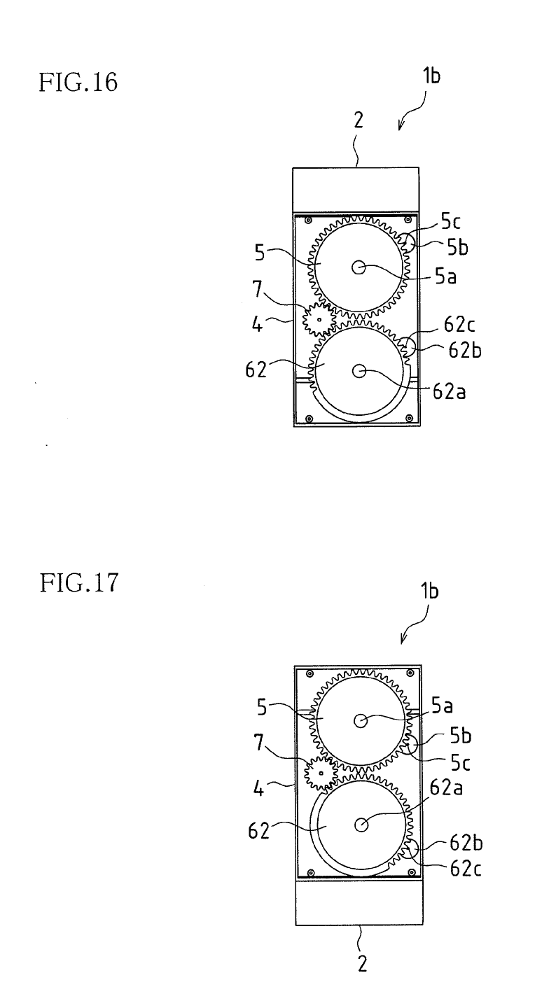

FIGS. 16-18 are plan views showing internal states of another example mobile terminal 1b in which a second rotating plate gear 62 has teeth along a portion of the entire circumference thereof.

In FIGS. 16-18, the range within which the teeth of the second rotating plate gear 62 are formed is determined so that, after being moved relative to the lower housing 2 in the CW direction to transition from the upper surface covered state (FIG. 16) to the rear portion-of-upper surface exposed state (FIG. 17), the upper housing 3 is prevented from moving further in the CW direction.

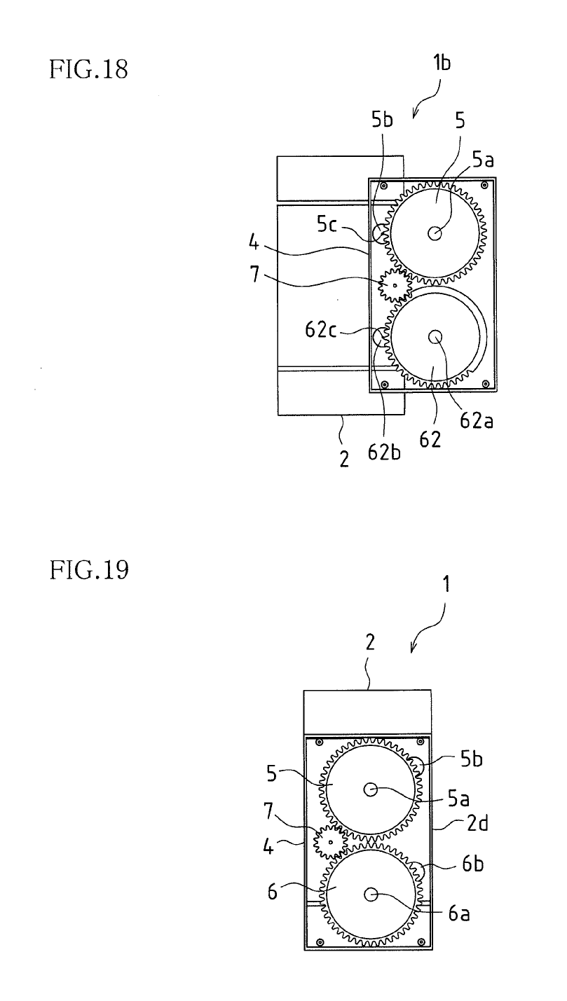

Also, the range within which the teeth of the second rotating plate gear 62 are formed is determined so that, after being moved relative to the lower housing 2 in the CCW direction to transition from the upper surface covered state (FIG. 16) to the center portion-of-upper surface exposed state (FIG. 18), the upper housing 3 is prevented from moving further in the CCW direction.

In this case, by moving the upper housing 3 relative to the lower housing 2 in a direction opposite to that in which the upper housing 3 has been originally moved, the upper housing 3 can be returned to the upper surface covered state (FIG. 16).

As shown in FIGS. 16-18, in the mobile terminal 1b, a first pivot shaft 5b and a second pivot shaft 62b are fixed to a first rotating plate gear 5 and a second rotating plate gear 62 so that a first pivot 5c and a second pivot 62c which are the center points of the first and second pivot shafts 5b and 62b are located outside the outer circumferences of the first and second rotating plate gears 5 and 62.

Alternatively, as shown in FIGS. 19-21, a first pivot shaft 5b and a second pivot shaft 6b may be fixed to a first rotating plate gear 5 and a and second rotating plate gear 6 so that a first pivot 5c and a second pivot 6c which are the center points of the first and second pivot shafts 5b and 6b are located on or inside the outer circumferences of the first and second rotating plate gears 5 and 6.

In this case, however, compared to FIGS. 8-10, the exposed portion of the upper surface 2a of the lower housing 2 is reduced when the upper housing 3 is in the center portion-of-upper surface exposed state as described above. Therefore, the configuration of FIGS. 8-10 is recommended.

As shown in FIGS. 8-10, in the mobile terminal 1, the middle gear 7 engages with the first and second rotating plate gears 5 and 6 to allow the first and second rotating plate gears 5 and 6 to rotate in synchronization with each other. In other words, the first and second rotating plate gears 5 and 6 are rotated in synchronization with each other by using the middle gear 7 which engages with the first and second rotating plate gears 5 and 6.

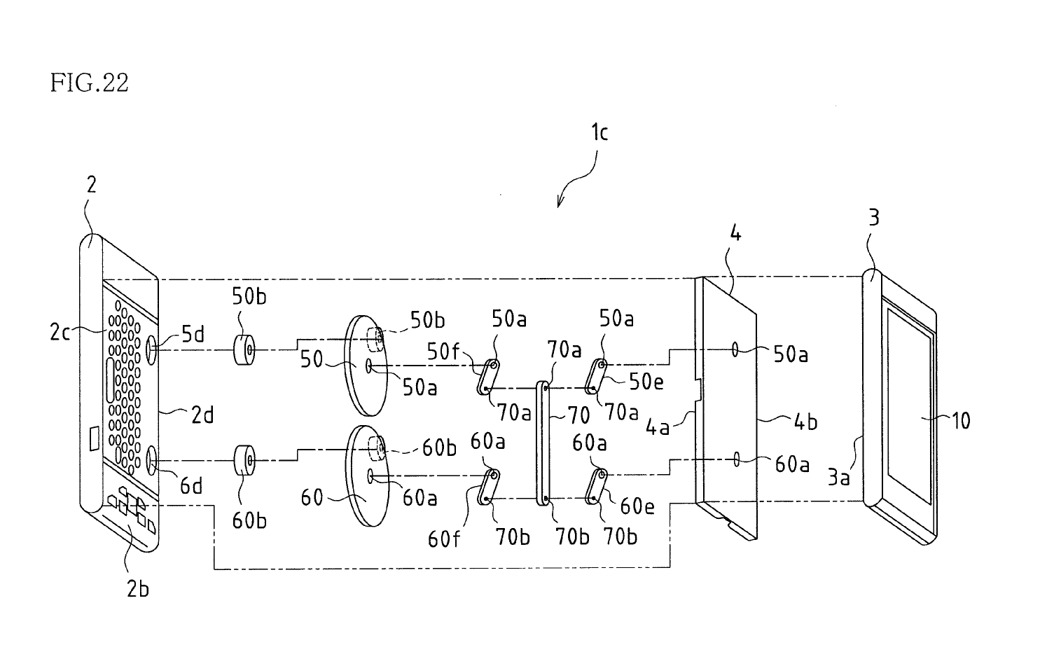

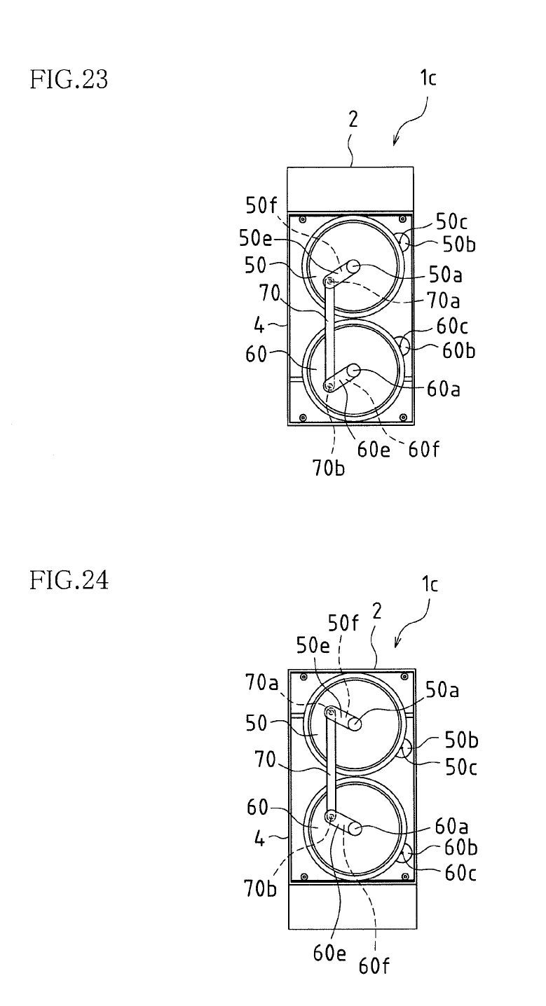

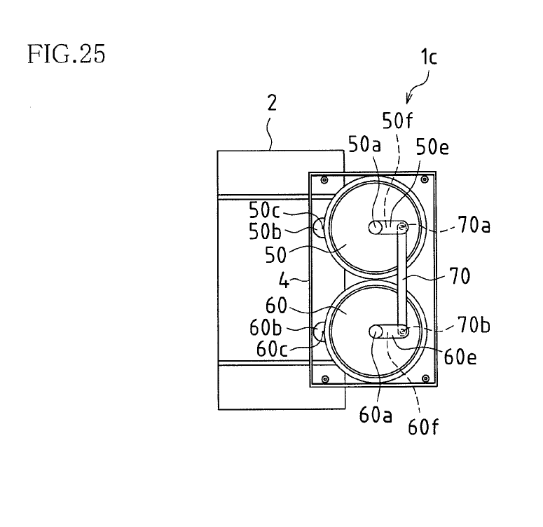

However, the synchronization of the rotation may be achieved by methods other than the method of using the middle gear 7. FIG. 22 is an exploded perspective view showing an internal state of a mobile terminal 1c to which an example of such a method is applied. FIGS. 23-25 are plan views of the mobile terminal 1c. Note that FIGS. 22 and 23 show the upper surface covered state, FIG. 24 shows the rear portion-of-upper surface exposed state, and FIG. 25 shows the center portion-of-upper surface exposed state.

In this method, a crank mechanism shown in FIG. 22 is used to prevent a synchronization shaft bar 70 from striking a first rotation center shaft 50a and a second rotation center shaft 60a while a first rotating plate 50 and a second rotating plate 60 are rotating.

The crank mechanism includes, instead of the first and second rotating plate gears 5 and 6 and the middle gear 7, the first rotating plate 50, the first rotation center shaft 50a, a first crank upper lever 50e, a first crank lower lever 50f, the second rotating plate 60, the second rotation center shaft 60a, a second crank upper lever 60e, a second crank lower lever 60f, the crank rod 70, a crank first linking shaft 70a, and a crank second linking shaft 70b.

Specifically, in FIG. 22, a front end of the crank rod 70 is rotatably fixed to a tip end of the first crank upper lever 50e and a tip end of the first crank lower lever 50f using the crank first linking shaft 70a. A base end of the first crank lower lever 50f is fixed to the first rotation center shaft 50a. The first crank upper lever 50e is rotatably supported by the rotating plate gear holder 4, i.e., the upper housing 3 so that a base end of the first crank upper lever 50e and the first rotation center shaft 50a are concentric.

Similarly, a rear end of the crank rod 70 is rotatably fixed to a tip end of the second crank upper lever 60e and a tip end of the second crank lower lever 60f using the crank second linking shaft 70b. A base end of the second crank lower lever 60f is fixed to the second rotation center shaft 60a, and the second crank upper lever 60e is rotatably supported by the rotating plate gear holder 4, i.e., the upper housing 3 so that a base end of the second crank upper lever 60e and the second rotation center shaft 60a are concentric.

With the above configuration, the first and second rotating plates 50 and 60 can rotate in synchronization with each other as shown in FIGS. 23-25. Note that, in the above case, in FIG. 22, the front end of the crank rod 70 may be rotatably attached directly to the first rotating plate 50 without using the first crank lower lever 50f. The same holds true for the second rotating plate 60.

The present invention can be embodied and practiced in other different forms without departing from the spirit and essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

This application claims priority on Patent Application No. 2009-172465 filed in Japan on Jul. 23, 2009, the entire contents of which are hereby incorporated by reference. Also, the documents cited herein are hereby incorporated by reference in their entirety.

### INDUSTRIAL APPLICABILITY

The present invention provides a mobile terminal including a lower housing and an upper housing in which the lower housing can freely transition between the upper surface covered state, the rear portion-of-upper surface exposed state, and the center portion-of-upper surface exposed state, and therefore, can be quickly operated. In this respect, the present invention is useful.

### DESCRIPTION OF REFERENCE NUMERALS

1 mobile terminal

1a mobile terminal

1b mobile terminal

1c mobile terminal

2 lower housing

2a upper surface of lower housing

2b rear portion of upper surface of lower housing

2c center portion of upper surface of lower housing

2d right side edge of lower housing

3 upper housing

3a lower surface of upper housing

4 rotating plate gear holder

4a lower surface of rotating plate gear holder

4b upper surface of rotating plate gear holder

5 first rotating plate gear

5a first rotation center shaft

5b first pivot shaft

5c first pivot

5d first pivot bearing hole

6 second rotating plate gear

6a second rotation center shaft

6b second pivot shaft

6c second pivot

6d second pivot bearing hole

7 middle gear

7a middle gear center shaft

10 display section

50 first rotating plate

50a first rotation center shaft

50b first pivot shaft

50c first pivot

50e first crank upper lever

50f first crank lower lever

51 first rotating plate gear

51a first rotation center shaft

51b first pivot shaft

51c first pivot

52 first rotating plate gear

52a first rotation center shaft

52b first pivot shaft

52c first pivot

60 second rotating plate

60a second rotation center shaft

60b second pivot shaft

60c second pivot

60e second crank upper lever

60f second crank lower lever

61 second rotating plate gear

61a second rotation center shaft

61b second pivot shaft

61c second pivot

62 second rotating plate gear

62a second rotation center shaft

62b second pivot shaft

62c second pivot

70 crank rod

70a crank first linking shaft

70b crank second linking shaft

1. A mobile terminal in which an upper housing provided and stacked on a lower housing is slidable relative to the lower housing, wherein
two rotating plates are provided side by side along a lower surface of the upper housing, and rotation center points of the rotating plates are rotatably supported by the upper housing,
two pivots are provided on the two respective rotating plates at points on circular paths having the same radius whose centers are the rotation center points of the rotating plates, and
the two pivots are rotatably supported by the lower housing so that the two pivots and the two rotation center points form the four corners of a parallelogram, and the two pivots are both located near a side edge of the lower housing.

2. The mobile terminal according to claim 1, wherein
the two rotating plates rotate in synchronization with each other.

3. The mobile terminal according to claim 1, wherein
the two rotating plates are arranged side by side in a front-rear direction,
the two pivots are both located near a side edge in a left-right direction of the lower housing,
a line joining the two rotation center points is located at substantially a middle in a left-right direction of the upper housing, and
in an upper surface covered state that an upper surface of the lower housing is covered by the upper housing, the pivots are located further forward than the respective rotation center points of the rotating plates.

4. The mobile terminal according to claim 3, wherein
when the upper housing is moved along the upper surface of the lower housing so that the rotation center points perform a circular motion around the respective pivots, the pivots relatively rotate on the respective circular paths, whereby the upper housing transitions between three states which are the upper surface covered state, a rear portion-of-upper surface exposed state that the upper housing is moved forward relative to the lower housing, so that a rear portion of the upper surface of the lower housing is exposed, and a center portion-of-upper surface exposed state that the upper housing is moved relative to the lower housing to one side in the left-right direction of the lower housing, so that a center portion and the other side in the left-right direction of the upper surface of the lower housing are exposed.

5. The mobile terminal according to claim 4, wherein
when the upper housing is moved from the upper surface covered state in a CW direction along the upper surface of the lower housing, the upper housing transitions to the rear portion-of-upper surface exposed state, then to the center portion-of-upper surface exposed state, and then back to the upper surface covered state.

6. The mobile terminal according to claim 4, wherein
when the upper housing is moved from the upper surface covered state in a CCW direction along the upper surface of the lower housing, the upper housing transitions to the center portion-of-upper surface exposed state, then to the rear portion-of-upper surface exposed state, and then back to the upper surface covered state.

7. The mobile terminal according to claim 1, wherein
the lower housing includes bearing holes in each of which a cylindrical pivot shaft is rotatably inserted, the pivot shaft having a center at a corresponding one of the pivots, and the pivot shafts are fixed to the respective rotating plates.

8. The mobile terminal according to claim 1, wherein
the two rotating plates include gears having the same shape which rotate independently of each other, and a middle gear which engages with both of the two gears.

9. The mobile terminal of claim 8, wherein
the two gears and the middle gear are provided and recessed in the upper housing below the lower surface of the upper housing.

10. The mobile terminal according to claim 8, wherein
the lower housing includes bearing holes in each of which a cylindrical pivot shaft is rotatably inserted, the pivot shaft having a center at a corresponding one of the pivots, and the pivot shaft is fixed to the rotating plate such that the pivot is located outside an outer circumference of the corresponding gear.

11. The mobile terminal according to claim 8, wherein
one of the gears has teeth formed on a portion of an entire circumference thereof.

12. The mobile terminal according to claim 2, wherein
the two rotating plates are arranged side by side in a front-rear direction,
the two pivots are both located near a side edge in a left-right direction of the lower housing,
a line joining the two rotation center points is located at substantially a middle in a left-right direction of the upper housing, and
in an upper surface covered state that an upper surface of the lower housing is covered by the upper housing, the pivots are located further forward than the respective rotation center points of the rotating plates.

13. The mobile terminal according to claim 5, wherein
when the upper housing is moved from the upper surface covered state in a CCW direction along the upper surface of the lower housing, the upper housing transitions to the center portion-of-upper surface exposed state, then to the rear portion-of-upper surface exposed state, and then back to the upper surface covered state.

14. The mobile terminal according to claim 2, wherein
the lower housing includes bearing holes in each of which a cylindrical pivot shaft is rotatably inserted, the pivot shaft having a center at a corresponding one of the pivots, and the pivot shafts are fixed to the respective rotating plates.

15. The mobile terminal according to claim 3, wherein
the lower housing includes bearing holes in each of which a cylindrical pivot shaft is rotatably inserted, the pivot shaft having a center at a corresponding one of the pivots, and the pivot shafts are fixed to the respective rotating plates.

16. The mobile terminal according to claim 4, wherein
the lower housing includes bearing holes in each of which a cylindrical pivot shaft is rotatably inserted, the pivot shaft having a center at a corresponding one of the pivots, and the pivot shafts are fixed to the respective rotating plates.

17. The mobile terminal according to claim 5, wherein
the lower housing includes bearing holes in each of which a cylindrical pivot shaft is rotatably inserted, the pivot shaft having a center at a corresponding one of the pivots, and the pivot shafts are fixed to the respective rotating plates.

18. The mobile terminal according to claim 6, wherein
the lower housing includes bearing holes in each of which a cylindrical pivot shaft is rotatably inserted, the pivot shaft having a center at a corresponding one of the pivots, and the pivot shafts are fixed to the respective rotating plates.

19. The mobile terminal according to claim 2, wherein
the two rotating plates include gears having the same shape which rotate independently of each other, and a middle gear which engages with both of the two gears.

20. The mobile terminal according to claim 3, wherein
the two rotating plates include gears having the same shape which rotate independently of each other, and a middle gear which engages with both of the two gears.
